(19) United States
(12) Patent Application Publication
(10) Pub. No.: US 2014/0249900 A1
(43) Pub. Date: Sep. 4, 2014

(54) AFFILIATE SYSTEM, AFFILIATE METHOD, AND SERVER

(71) Applicant: YAHOO JAPAN CORPORATION, Tokyo (JP)

(72) Inventors: Hideo OZAWA, Tokyo (JP); Takeshi SEKIGUCHI, Tokyo (JP)

(73) Assignee: YAHOO JAPAN CORPORATION, Tokyo (JP)

(21) Appl. No.: 14/176,507

(22) Filed: Feb. 10, 2014

(30) Foreign Application Priority Data
Mar. 1, 2013 (JP) 2013-041152

(51) Int. Cl. G06Q 30/02

(52) U.S. Cl. CPC G06Q 30/0214
USPC 705/14.16

(57) ABSTRACT

An affiliate system according to the embodiment acquires an introduction request including information on a product or service that a user of a first terminal decides to introduce to a user of a second terminal among products or services purchased or used by the user of the first terminal, selects from among users of respective second terminals, the user of the second terminal who is associated with the user of the first terminal and who visits a purchase site or use site of the product or service specified in the introduction request, and notifies introduction information corresponding to the introduction request to the second terminal of the selected user. If the user of the second terminal purchases or uses the product or service on the basis of the introduction information, a reward is provided to the user of the first terminal.

### CROSS-REFERENCE TO RELATED APPLICATIONS

The present application claims priority to and incorporates by reference the entire contents of Japanese Patent Application No. 2013-041152 filed in Japan on Mar. 1, 2013.

### BACKGROUND OF THE INVENTION

1. Field of the Invention

The present invention relates to an affiliate system, an affiliate method, and a server.

2. Description of the Related Art

Affiliate adverting is known as one of advertising forms. Generally in affiliate advertising, an affiliater sets an advertising banner on a site such as a blog or sets a link to an advertising page in a text of an email magazine to lead to a site of an advertiser. When purchase occurs on the site of the advertiser by such leading, a reward occurs to the affiliater.

Generally in such affiliate advertising, the affiliater actively performs such things as introducing a product or service of the advertiser and making efforts to increase the number of access to the site of the advertiser. However, actually the affiliater has not purchased or used the product or service of the advertiser in some cases, and the advertisement lacks credibility in many cases.

In order to deal with such a problem, an advertising system has been proposed, which can perform affiliate advertising between member users associated by a social networking service (SNS) by making use of a comment function of the SNS (For example, see Japanese Patent Application Laid-open No. 2012-242976).

However, in the technology described in Japanese Patent Application Laid-open No. 2012-242976, if a member user attempts to perform affiliate advertising, affiliate advertising is performed on all the other member users associated with the member user. Hence, affiliate advertisements distributed to the member users include many products and services that they are not at all interested in, and conversely, the effect of affiliate advertising is inhibited in many cases.

### SUMMARY OF THE INVENTION

According to an exemplary embodiment, an affiliate system includes a first terminal, a plurality of second terminals, and a server. The server includes an associated information storage unit, a visit history storage unit, an introduction information acquisition unit, a selection unit, an introduction information notification unit, and a provision unit. The associated information storage unit stores information to associate a user of the first terminal with a user of the second terminal. The visit history storage unit stores, as visit history information, information on a site visited by the user of the second terminal. The introduction information acquisition unit acquires an introduction request including information on a product or a service that the user of the first terminal decides to introduce to the user of the second terminal among products or services purchased or used by the user of the first terminal. The selection unit selects, from among the users of the respective second terminals, the user of the second terminal who is associated with the user of the first terminal and who visits a purchase site or use site of the product or service specified in the introduction request, on the basis of the information stored in the associated information storage unit and the information stored in the visit history storage unit. The introduction information notification unit notifies introduction information corresponding to the introduction request acquired by the introduction information acquisition unit to the second terminal of the user selected by the selection unit. The provision unit provides a reward to the user of the first terminal when the user of the second terminal purchases or uses the product or service on the basis of the introduction information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory view of an affiliate method according to an embodiment;

FIG. 2 is a diagram illustrating an example of a specific configuration of an affiliate system according to the embodiment;

FIG. 3 is a diagram illustrating an example of a target information table stored in a storage unit of a terminal apparatus;

FIG. 4 is a diagram illustrating an example of a screen displayed on a display unit by an affiliate app;

FIGS. 5A to 5C are diagrams illustrating examples of a display screen displayed by a display control unit;

FIG. 6 is a diagram illustrating an example of a transaction information table stored in a transaction target information DB;

FIG. 7 is a diagram illustrating an example of a user information table stored in a user information DB;

FIG. 8 is a flowchart of information processing in the terminal apparatus; and

FIG. 9 is a flowchart of information processing in an affiliate server.

### DETAILED DESCRIPTION OF THE PREFERRED EMBODIMENTS

Hereinafter, an embodiment of an affiliate system, an affiliate method, and a server according to the present application will be described in detail with reference to the drawings. The embodiment shall not limit the affiliate system, the affiliate method, and the server according to the present application. Moreover, in the following, a database is expressed as DB.

1. Affiliate Method

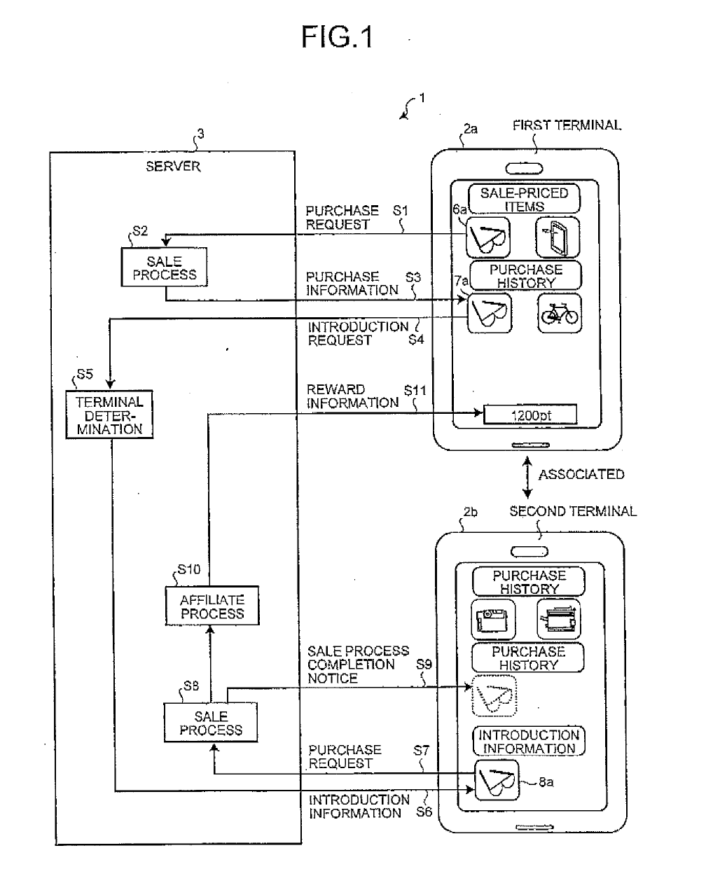

Firstly, an example of the affiliate method according to the embodiment will be described. FIG. 1 is an explanatory view of the affiliate method according to the embodiment.

The affiliate method according to the embodiment is realized by, for example, an affiliate system 1 illustrated in FIG. 1. As illustrated in FIG. 1, the affiliate system 1 includes a first terminal 2a, a second terminal 2b, and a server 3. The first terminal 2a and the second terminal 2b can communicate with the server 3 via an unillustrated network.

An application dedicated to be used for affiliate advertising (hereinafter described as the affiliate app) is installed on the first terminal 2a and the second terminal 2b, and affiliate advertising is effectively performed using a function of the affiliate app. In the following, assume that the affiliate app has been activated in the first terminal 2a and the second terminal 2b, and control units of the first terminal 2a and the second terminal 2b are being operated by the affiliate app.

Icons indicating products are displayed on a display unit of the first terminal 2a by the function of the affiliate app, and a user of the first terminal 2a (hereinafter described as the first terminal user in some cases) operates the icon displayed on the display unit and accordingly can purchase or introduce the product. The icons displayed on the display unit of the first terminal 2a include, for example, an icon of a sale-priced item, and an icon of a product that the first terminal user has purchased (hereinafter described as a purchased icon).

The first terminal user selects an icon 6a of a sale-priced item by, for example, a flick operation, and then the control unit of the first terminal 2a makes a request to the server 3 to purchase a product corresponding to the icon 6a (for example, the icon of sunglasses) (Step S1).

The server 3 performs a sale process on the purchase request of the first terminal 2a (Step S2). Such a sale process is a sale process of the product corresponding to the icon 6a, and accordingly a payment process, delivery arrangement, and the like of the product corresponding to the icon 6a are performed for the first terminal user. Furthermore, the server 3 transmits purchase information to the first terminal 2a (Step S3).

The purchase information transmitted from the server 3 to the first terminal 2a includes information on the product corresponding to the icon 6a (for example, product ID, product name, URL of the server 3, and icon information). The control unit of the first terminal 2a displays on the display unit a purchased icon 7a corresponding to the purchase information on the basis of the icon information.

Afterwards, the first terminal user selects the purchased icon 7a by, for example, the flick operation. The control unit of the first terminal 2a then makes a request to the server 3 to introduce the product corresponding to the purchased icon 7a (Step S4).

When accepting the introduction request of the first terminal 2a, the server 3 determines the second terminal 2b that is associated with the first terminal 2a and that a purchase site of the product specified in the introduction request is included in a visit site of a user (Step S5), and transmits introduction information corresponding to the purchased icon 7a to the second terminal 2b (Step S6).

The process of Step S5 will be specifically described here. The server 3 stores in its internal storage unit information that associates a user ID of the first terminal user with a user ID of the user of the second terminal 2b (described as the second terminal user in some cases) (for example, friend registration information), and history information on sites that the second terminal user has visited (hereinafter described as the visit history information). Moreover, the introduction request transmitted from the first terminal 2a includes the user ID corresponding to the first terminal user, and information on the product corresponding to the purchased icon 7a (for example, an ID of the product).

Firstly, the server 3 determines a terminal of a user associated with the first terminal user on the basis of the user ID included in the introduction request. As described above, the second terminal user is set as the user associated with the first terminal user. The server 3 determines that a terminal of a user associated with the first terminal user is the second terminal 2b.

Next, the server 3 determines on the basis of the visit history information whether or not the second terminal user has visited the purchase site of the product specified in the introduction request. The introduction request includes a URL of the server 3 as described above. The server 3 determines on the basis of the visit history information, for example, whether or not the second terminal user has visited a page of the product corresponding to the introduction request (for example, a page of the server 3 where the product is sold, and a page of its manufacturer). If the second terminal user has visited the page of the product corresponding to the introduction request, then the server 3 determines that the second terminal user has visited the purchase site of the product specified by the introduction request.

In this manner, if determining that the second terminal user is associated with the first terminal user, and that the second terminal user has visited the purchase site of the product specified in the introduction request, the server 3 transmits introduction information to the second terminal 2b. The introduction information includes information on the product corresponding to the introduction request (for example, an ID of the introduced product, product name, URL of the server 3, and icon information) and the user ID of the first terminal user who is the introducer. The control unit of the first terminal 2a displays an introduction icon 8a on the display unit on the basis of the icon information included in the introduction information acquired from the server 3. Moreover, the second terminal 2b stores the information on the product included in the introduction information as information on the product corresponding to the introduction icon 8a.

Afterwards, the second terminal user selects the introduction icon 8a by, for example, the flick operation, and then the control unit of the second terminal 2b makes a request to the server 3 to purchase the product corresponding to the introduction icon 8a (hereinafter described as the introduced product in some cases) (Step S7). Such a purchase request includes information on the URL of the server 3 where the introduced product is purchased, and the user ID of the first terminal user who is the introducer. The URL of the server 3 also includes the ID of the introduced product. Moreover, the URL of the server 3 can also include the information on the user ID of the first terminal user.

The server 3 performs a sale process on the purchase request of the second terminal 2b (Step S8). Such a sale process is a similar process to the process of Step S2. Moreover, the server 3 transmits a sale process completion notice to the second terminal 2b (Step S9). Furthermore, since the purchase request of the second terminal 2b is based on the introduction information of the first terminal 2a, the server 3 performs an affiliate process that provides a reward to the first terminal user who is the introducer (Step S10). The server 3 can identify, for example, the introduced product and the first terminal user from the information included in the purchase request.

A reward is provided, for example, by adding points at a predetermined rate of the amount of the introduced product (hereinafter described as the affiliate points) to points that the first terminal user has. The server 3 transmits to the first terminal 2a information on the affiliate points provided to the first terminal user (Step S11).

The points are a virtual value that can be used for, for example, a service (for example, online shopping, an online game, and an auction) offered by the server 3. Such points may be a virtual value that can be used for another service. The server 3 can also provide a reward by transferring an amount at a predetermined rate of the amount of the introduced product (hereinafter described as the affiliate fee) into an account of the first terminal user.

In this manner, in the affiliate method according to the embodiment, if the first terminal user who actually purchased a product introduces the purchased product, a terminal of a user who is associated with the first terminal user (for example, who is registered as a friend), and who has visited a purchase site of the product specified in the introduction request is identified, and the introduction information is transmitted to the identified terminal.

Therefore, the introduction information is not transmitted to all the terminals of the users associated with the first terminal user, and advertisement distribution like spam can be inhibited. Hence, it is possible to prevent a situation where the introduction information tends to be ignored.

In addition, the introduction information is notified to a terminal of a user who has visited the purchase site of the product specified in the introduction request and accordingly, the effect of affiliate advertising can be effectively exerted. For example, if the purchase site of the product specified in the introduction request is a predetermined site of the server 3, a terminal user who has visited the predetermined site may be interested in the product specified in the introduction request and be considering its purchase. The introduction information is notified to the terminal user. Accordingly, the effect of affiliate advertising can be more effectively exerted.

In the above example, online purchase of a product has been described. However, affiliate advertising can also be similarly performed on offline purchase of a product. Moreover, affiliate advertising can also be similarly performed on not a product but the use of a service (for example, offering food at a restaurant and offering a movie at a theater). Moreover, the introduction information can also include information on a discount coupon and other recommended products and services. Hereinafter, a specific description will be given of configuration examples and operations of the affiliate system 1 according to the embodiment. In the following examples, the description of information on a sale-priced item is omitted. Moreover, a product and a service may be collectively described as a transaction target.

2. Configuration of Affiliate System 1

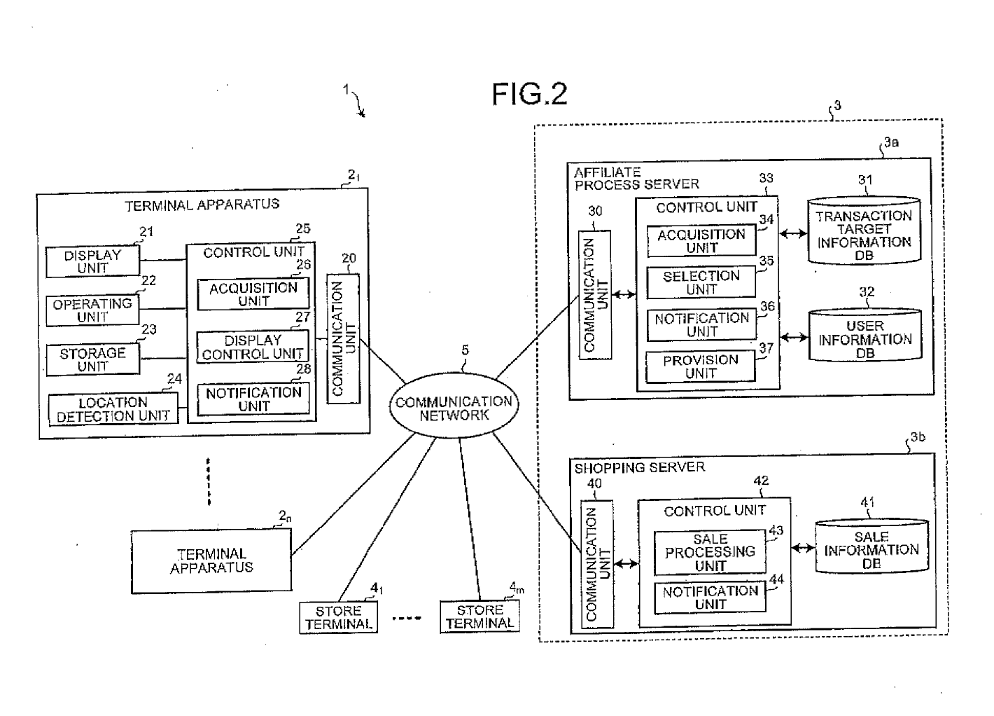

FIG. 2 is a diagram illustrating an example of a specific configuration of the affiliate system 1 according to the embodiment. As illustrated in FIG. 2, the affiliate system 1 includes terminal apparatuses 2₁ to 2ₙ (hereinafter collectively called the terminal apparatus 2 in some cases), the server 3, and store terminals 4₁ to 4ₘ (hereinafter collectively called the store terminal 4 in some cases).

The terminal apparatus 2 is a terminal apparatus such as a smartphone or a PC (Personal computer), and can communicate with the server 3 via a communication network 5. The communication network 5 is an IP (Internet Protocol) network such as the Internet.

The affiliate app is installed on the terminal apparatuses 2. The terminal apparatus 2 functions as the first terminal 2a, for example, if making an introduction request to the server 3, and functions as the second terminal 2b if making a purchase request corresponding to the introduction request.

The server 3 includes an affiliate server 3a and a shopping server 3b. The servers 3a and 3b are connected to the communication network 5, and can communicate with the terminal apparatus 2 via the communication network 5.

The store terminal 4 is a terminal apparatus placed in a store that offers a product or a service, and is connected to an unillustrated barcode reader, an NFC (Near Field Communication) device, or the like. Such a store terminal 4 transmits to the affiliate server 3a information read by the barcode reader or the NFC device from the terminal apparatus 2 as sale information. Consequently, information on a product purchased or a service used by a user of the terminal apparatus 2 in the store is notified to the affiliate server 3a.

NFC includes, for example, Felica and ISO/IEC 14443 (MIDARE). The communication in NFC is not limited to radio waves, but can also use, for example, infrared communication, visible light communication, and sound waves.

2.1. Configuration of Terminal Apparatus 2

As illustrated in FIG. 2, the terminal apparatus 2 includes a communication unit 20, a display unit 21, an operating unit 22, a storage unit 23, a location detection unit 24, and a control unit 25. The communication unit 20 is connected to the communication network 5 in a wired or wireless manner, and transmits and receives information to and from the affiliate server 3a and the shopping server 3b, which are connected to the communication network 5.

The display unit 21 is a touch panel display. A user of the terminal apparatus 2 (hereinafter described as the terminal user in some cases) operates on a screen of the display unit 21 with the finger or the like and accordingly can operate on an operation screen of the affiliate app displayed on the display unit 21. Such a display unit 21 is, for example, a small LCD (Liquid Crystal Display) or organic EL display.

The operating unit 22 includes a keyboard including keys for inputting characters, numerals and spaces, an enter key, and an arrow key, a power button, and the like. In the following, an operation on the screen of the display unit 21 by the terminal user and an operation on the operating unit 22 by the terminal user are described as the operation by the terminal user.

The storage unit 23 is, for example, a semiconductor memory device such as a RAM (Random Access Memory) or a flash memory, or a storage device such as a hard disk or an optical disc. Various programs, setting data, and the like are stored in the storage unit 23. The programs stored in the storage unit 23 include, for example, an OS (Operating System) and the affiliate app. The affiliate app can be acquired from a server such as the affiliate server 3a.

The location detection unit 24 has a GPS (Global Positioning System) receiving function and acquires information on a current location of the terminal apparatus 2 (hereinafter described as the location information). The location information is latitude and longitude, but may be an address.

The control unit 25 is realized by an integrated circuit such as an ASIC (Application Specific Integrated Circuit) or an FPGA (Field Programmable Gate Array). Moreover, for example, a CPU (Central Processing Unit) or MPU (Micro Processing Unit) executes the programs stored in the storage unit 23 using an unillustrated internal RAM as a workspace and accordingly the control unit 25 realizes or executes functions and operations of information processing, which is described below.

Such a control unit 25 executes the affiliate app, the program data of which are stored in the storage unit 23, and accordingly functions as an acquisition unit 26, a display control unit 27, a notification unit 28. Moreover, the control unit 25 executes the affiliate app, the program data of which are stored in the storage unit 23, and accordingly stores the setting data and the like of the affiliate app in the storage unit 23. The configuration of the control unit 25 is not limited to such a configuration but may be another configuration as long as it is a configuration that performs information processing, which is described below.

2.1.1. Acquisition Unit 26

The acquisition unit 26 acquires information notified by the affiliate server 3a via the communication network 5 via the communication unit 20, and stores the information in the storage unit 23. The information notified by the affiliate server 3a includes information such as the purchase information and the introduction information.

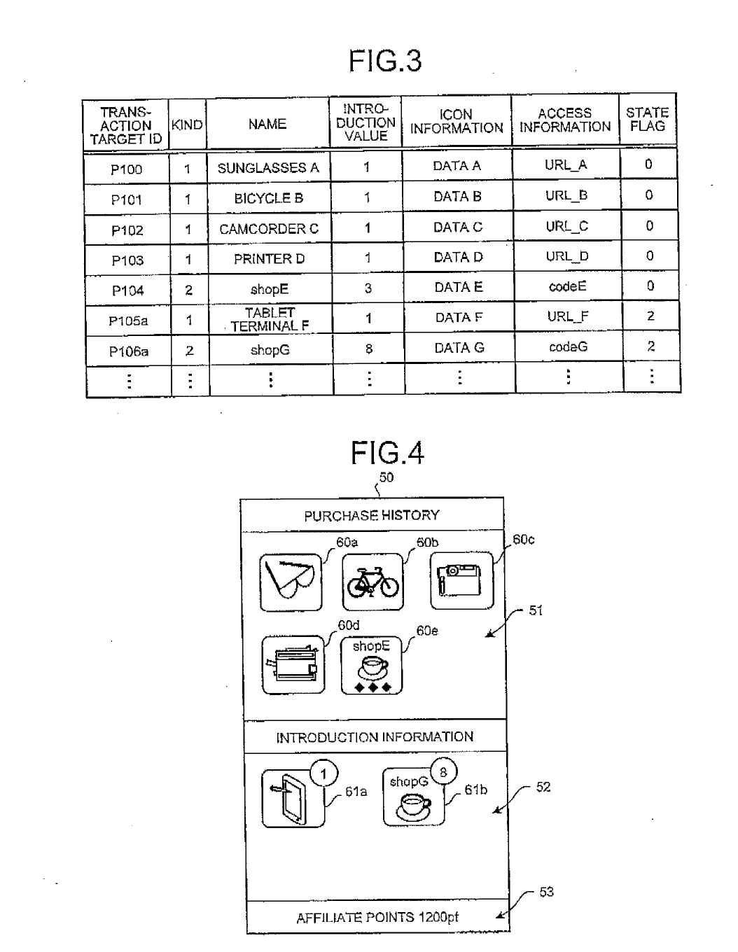

If the information acquired via the communication network 5 is the purchase information or introduction information, the acquisition unit 26 sets the acquired information in a target information table of the storage unit 23. FIG. 3 is a diagram illustrating an example of the target information table.

As illustrated in FIG. 3, the target information table is information where a “kind,” a “name,” an “introduction value,” “icon information,” “access information,” and a “state flag” are associated according to the “transaction target ID”.

The “transaction target ID” is information on a product or service to be a transaction target, and is specifically information allocated to a product purchased or a service used by the terminal user and to a product or service introduced by another terminal user. In the example illustrated in FIG. 3, information on a transaction target ID that does not end with an alphabet is the purchase information of the terminal user. Information on a transaction target ID that ends with an alphabet is the introduction information introduced by another terminal user to the terminal user.

The “kind” is information indicating the kind of the transaction target, and “1” is set therein if the transaction target is a product, and “2” is set therein if the transaction target is a service.

The “name” is information indicating the name of a transaction target. In the example illustrated in FIG. 3, for example, the name of a transaction target with a transaction target ID “P100” is “sunglasses A,” and the name of a transaction target with a transaction target ID “P101” is a “bicycle B.”

The “introduction value” is a value indicating the evaluation of the purchase information, or a value indicating the evaluation of the introduction information. The larger the introduction value is, the higher the evaluation is. Such an introduction value is information provided by the affiliate server 3a.

The “icon information” is information for displaying a purchased icon corresponding to the purchase information, an introduction icon corresponding to the introduction information, or the like on the display unit 21 of the terminal apparatus 2. The information on the icon is, for example, still image data, animation data, and moving image data.

The “access information” is information to be read by the display control unit 27 or the notification unit 28 from the target information table in response to the action of the terminal user. The access information is information on a URL (Uniform Resource Locator) of a server in a case of an online transaction, and is, for example, information for a barcode in a case of an offline transaction. Such information for a barcode includes information such as a transaction target ID.

“URL_A” to “URL_F” illustrated in FIG. 3 are respectively pieces of information indicating sites of shopping pages on the shopping server 3b. The shopping server 3b is configured here to be one server. However, the shopping server 3b may be constructed of a plurality of servers. For example, servers may be respectively provided to “URL_A” to “URL_F.”

Moreover, for example, the transaction target ID of a transaction target and the user ID of a terminal user are added to the URL of a shopping page of the shopping server 3b in the access information in the case of an online transaction. Moreover, in the case of the introduction information, the user ID of an introducer, and the like are also added to the URL. It is also possible to notify information on the transaction target ID, the user ID, and the like to the shopping server 3b after accessing the URL of the shopping page of the shopping server 3b from the terminal apparatus 2.

Moreover, the access information in the case of an offline transaction is one where information including the transaction target ID of the transaction target corresponding to the introduction request (an introduction transaction target ID described below), the user ID of the introducer, and the user ID of the terminal user has two-dimensionally been barcoded, but is not limited to two-dimensional barcode information. For example, if NFC communication is provided to the terminal apparatus 2, the access information in the case of an offline transaction may be set as information including the transaction target ID of the transaction target corresponding to the introduction request, the user ID of the introducer, and the user ID of the terminal user, and configured to be transmitted to the store terminal 4.

The “state flag” is a flag indicating the state of an icon. “0” indicates a purchased icon that has not been introduced yet. “1” indicates a purchased icon that has already been introduced. “2” indicates an introduction icon.

The acquisition unit 26 updates the target information table whenever new transaction target information is acquired from the server 3. The acquisition unit 26 can also be configured to transmit to the server 3 information on a user ID and an acquisition condition that are stored in the storage unit 23, and acquire from the server 3 information that satisfies the acquisition condition among pieces of transaction target information corresponding to the user ID whenever the affiliate app is activated. Moreover, the target information table may be configured to include, for example, information on a reward (the affiliate points or affiliate fee).

2.1.2. Display Control Unit 27

The display control unit 27 creates a display image of the affiliate app on the basis of the setting data and the target information table that are stored in the storage unit 23 and displays the display image on the display unit 21. The setting data include various pieces of information such as the affiliate points, the user ID of the terminal user, and the acquisition condition.

FIG. 4 is a diagram illustrating an example of a screen displayed on the display unit 21 by the affiliate app. As illustrated in FIG. 4, a display screen 50 of the display unit 21 includes a purchase history area 51, an introduction information area 52, and a point information area 53.

Purchased icons 60a to 60e based on the purchase information (hereinafter collectively called the purchased icon 60 in some cases) are displayed in the purchase history area 51. The purchased icons 60a to 60e are displayed by the display control unit 27 on the basis of “data A” to “data E” being icon information corresponding to the transaction target IDs “P100” to “P104” illustrated in FIG. 3.

The display control unit 27 considers the introduction value when displaying the purchased icon 60. For example, the introduction value of the transaction target ID “P104” illustrated in FIG. 3 is “3” and accordingly the purchased icon 60e includes “♦♦♦” corresponding to the introduction value “3” as information indicating the introduction value. Consequently, the terminal user can distinguish the purchased icon 60 having a high introduction value at a glance. In the example illustrated in FIG. 4, graphics such as “♦♦♦” are added, but the display control unit 27 can also express the introduction value by the shape, color, size, and the like of the purchased icon 60.

Introduction icons 61a and 61b (hereinafter collectively called the introduction icon 61 in some cases) based on the introduction information introduced by another terminal user are displayed in the introduction information area 52. The introduction icons 61a and 61b are displayed by the display control unit 27 on the basis of the “data F,” and “data G” being the icon information corresponding to the transaction target IDs “P105a,” and “P106a” illustrated in FIG. 3.

The display control unit 27 considers the introduction value when displaying the introduction icon 61. For example, the introduction value of the transaction target ID “P105a” illustrated in FIG. 3 is “1” and accordingly the introduction icon 61a includes a character of “1” corresponding to the introduction value “1” as information indicating the introduction value. Moreover, the introduction value of the transaction target ID “P106a” is “8” and accordingly the introduction icon 61b includes a character of “8” corresponding to the introduction value “8” as information indicating the introduction value. Consequently, the terminal user can distinguish the introduction icon 61 having a high introduction value at a glance. In the example illustrated in FIG. 4, numerals are added, but the display control unit 27 can also express the introduction value by the shape, color, size, and the like of the introduction icon 61.

The affiliate points acquired by the terminal user are displayed in the point information area 53. The affiliate points are information acquired by the acquisition unit 26 from the affiliate server 3a. With the affiliate points, the terminal user can purchase or use a product or service traded, for example, on the shopping server 3b.

2.1.3. Notification Unit 28

If the purchased icon 60 or the introduction icon 61 is selected by the operation by the terminal user, the notification unit 28 outputs predetermined information to an access destination in accordance with the selection target and the selection method.

For example, if the flick operation is performed by the operation of the terminal user on the purchased icon 60 in the purchase history area 51, the notification unit 28 determines that the purchased icon 60 has been selected as the introduction target, and makes an introduction request to the affiliate server 3a.

If making an introduction request, the notification unit 28 acquires from the target information table of the storage unit 23 information on a transaction target corresponding to the purchased icon 60 to have become an operation target, and acquires the user ID of the terminal user from the setting data. An introduction request including the user ID of the terminal user and the information on the transaction target corresponding to the purchased icon 60 is made to the affiliate server 3a.

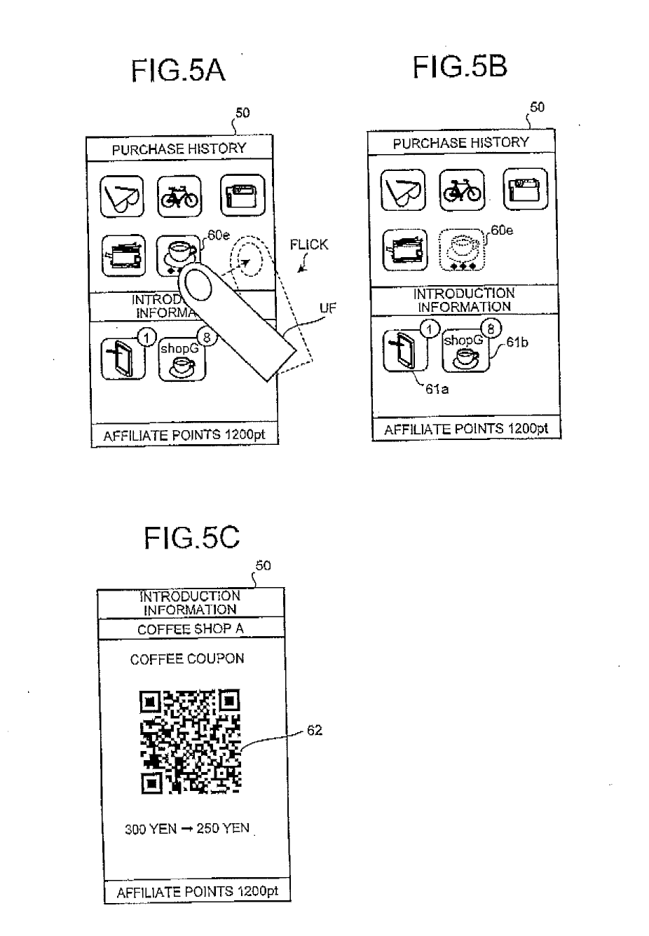

FIGS. 5A to 5C are diagrams illustrating examples of the display screen 50 displayed by the display control unit 27. As illustrated in FIG. 5A, if the terminal user flicks the purchased icon 60e with a finger UF, the notification unit 28 acquires the transaction target ID “P104” from the target information table. The notification unit 28 then makes an introduction request including the acquired transaction target ID “P104” and the user ID stored in the storage unit 23 to the affiliate server 3a.

If the affiliate server 3a accepts the introduction request, an introduction acceptance response is transmitted from the affiliate server 3a. If receiving the introduction acceptance response via the communication unit 20, the notification unit 28 changes the state flag of the transaction target corresponding to the introduction request from “0” to “1” in the target information table. Consequently, a change is added by the display control unit 27 to the display state of the purchased icon 60.

For example, as illustrated in FIG. 5B, the display control unit 27 increases the degree of transparency of the purchased icon 60 and makes the display state of the purchased icon 60 different from that of the purchased icon 60 for which an introduction request has not been made. Consequently, the terminal user can differentiate at a glance between the purchased icon 60 for which an introduction request has been made and the purchased icon 60 for which an introduction request has not been made. The display control unit 27 can also change the display state by the shape, color, size, and the like of the purchased icon 60, and add the character “introduced” to the purchased icon 60.

Moreover, for example, if the flick operation is performed on the introduction icon 61 by the operation of the terminal user in the introduction information area 52, the notification unit 28 determines that the introduction icon 61 has been selected as a purchase target, and makes a purchase request to the affiliate server 3a.

If making a purchase request, the notification unit 28 acquires information on a transaction target corresponding to the introduction icon 61 to have become an operation target from the target information table of the storage unit 23, and acquires the user ID of the terminal user from the setting data. A purchase request including the user ID of the terminal user and the information on the transaction target corresponding to the introduction icon 61 is made to the shopping server 3b.

For example, if the terminal user flicks the introduction icon 61a with the finger UF on the display screen 50 illustrated in FIG. 5B, the notification unit 28 acquires from the target information table the access information “URL_F” as information on the transaction target ID “P105a.” The notification unit 28 then accesses a shopping page of the shopping server 3b indicated by “URL_F” via the communication network 5. If the terminal user completes the transaction of the transaction target on the shopping page, the purchased information is notified from the shopping server 3b to the affiliate server 3a as described below.

Moreover, if the terminal user flicks the introduction icon 61b with the finger UF on the display screen 50 illustrated in FIG. 5B, the notification unit 28 acquires from the target information table the access information “codeG” as information on the transaction target ID “P106a.” Moreover, the notification unit 28 acquires the user ID of the user terminal from the setting data. The notification unit 28 then creates a two-dimensional barcode image 62 in accordance with the information including the access information “codeG” and the user ID of the user terminal, and displays the two-dimensional barcode image 62 on the display unit 21, for example as illustrated in FIG. 5C. Such a two-dimensional barcode image 62 is read by a barcode reader of the store terminal 4, and the purchased information is notified from the store terminal 4 to the affiliate server 3a.

If an NFC device is provided to the terminal apparatus 2, the notification unit 28 can also transmit the access information “codeG” and the user ID of the user terminal from the NFC device to the store terminal 4.

Moreover, the notification unit 28 repeatedly transmits location information acquired by the location detection unit 24 to the affiliate server 3a at predetermined intervals. The transmission timing of the affiliate server 3a can be set by the operation of the terminal user, and the setting data are updated by the operation of the terminal user. If the setting date are updated, the notification unit 28 transmits location information to the affiliate server 3a at transmission timings based on the updated setting data.

3. Affiliate Server 3a

Next, the affiliate server 3a will be described. As illustrated in FIG. 2, the affiliate server 3a includes a communication unit 30, a transaction target information DB 31, a user information DB 32, and a control unit 33. Furthermore, the control unit 33 includes an acquisition unit 34, a selection unit 35, a notification unit 36, and a provision unit 37.

The communication unit 30 is an interface such as an NIC (Network Interface Card). The control unit 33 transmits and receives various pieces of information to and from the shopping server 3b and the terminal apparatus 2 via the communication unit 30 and the communication network 5.

The transaction target information DB 31 and the user information DB 32 are, for example, hard disks, semiconductor memory devices such as a RAM and a flash memory, and storage devices such as an optical disc. The transaction target information DB 31 and the user information DB 32 may be constructed of one DB.

The control unit 33 is realized by an integrated circuit such as an ASIC or an FPGA. Moreover, a CPU or an MPU executes programs stored in an internal storage device using a RAM as a workspace and accordingly the control unit 33 functions as the acquisition unit 34, the selection unit 35, the notification unit 36, and the provision unit 37. The configuration of the control unit 33 is not limited to such a configuration but may be another configuration as long as it is a configuration that performs information processing, which is described below.

3.1. Acquisition Unit 34

The acquisition unit 34 acquires various pieces of information via the communication network 5, and updates a transaction information table of the transaction target information DB 31 and a user information table of the user information DB 32 on the basis of the acquired information. The information acquired by the acquisition unit 34 includes, for example, sale information of the terminal user transmitted from the shopping server 3b and the store terminal 4, and information included in an introduction request transmitted from the terminal apparatus 2.

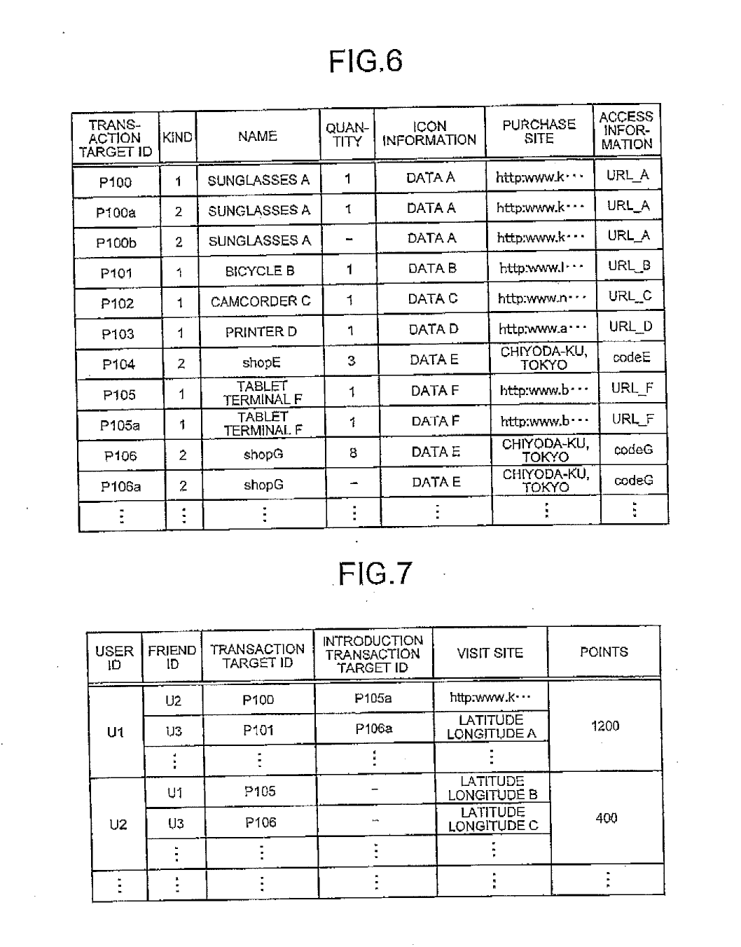

FIG. 6 is a diagram illustrating an example of the transaction information table stored in the transaction target information DB 31. As illustrated in FIG. 6, the transaction information table is information where a “kind,” a “name,” a “quantity,” “icon information,” a “purchase site,” and “access information” are associated according to the “transaction target ID.”

The “transaction target ID,” the “kind,” the “name,” the “icon information,” and the “access information” are the same information as the target information table of the terminal apparatus 2. The “quantity” is the quantity of a product purchased by the terminal user or the number of use of a service used by the terminal user.

The “purchase site” is a site where the terminal user traded a transaction target. For example, the URL “URL_A” of the shopping page of the “sunglasses A” is set as the purchase site of the transaction target ID “P100,” and the address of “shopE” is set as the purchase site of the transaction target ID “P104.”

The “access information” is information for trading a transaction target. For example, the URL “URL_A” of the shopping page of the “sunglasses A” is set as the access information of the transaction target ID “P100,” and the barcode information “codeE” is set as the access information of the transaction target ID “P104.”

FIG. 7 is a diagram illustrating an example of the user information table stored in the user information DB 32. As illustrated in FIG. 7, the user information table is information where a “friend ID,” a “transaction target ID,” an “introduction transaction target ID,” a “visit site,” and “points” are associated according to the “user ID.”

The “user ID” is identification information unique to the terminal user, and is a user ID allocated to the terminal user for, for example, a service offered by the server 3.

The “friend ID” is a user ID of another terminal user who has been registered as a friend by the terminal user. In terms of the friend registration, a friend ID is notified from the notification unit 28 of the terminal apparatus 2 to the affiliate server 3a, for example, by inputting a user ID of another terminal user on a friend registration screen (not illustrated) of the affiliate app. The acquisition unit 34 sets the friend ID transmitted from the terminal apparatus 2 in the user information table. The acquisition unit 34 can also acquire a friend ID from an SNS (Social Networking Service) server (not illustrated) by inputting a user ID of the SNS joined by the terminal user on the friend registration screen.

The “transaction target ID” is the same information as the “transaction target ID” illustrated in FIG. 3. Moreover, the “introduction transaction target ID” is identification information allocated to information on a transaction target introduced by another terminal user.

The “visit site” is information on a site where the terminal user has visited, and includes information on a site in the virtual space and information on a site in the real space. The site in the virtual space is, for example, a URL of a page of a server connected to the communication network 5 (for example, a shopping page of the shopping server 3b). The site in the real space is, for example, location information detected by the location detection unit 24 of the terminal apparatus 2.

The “points” are the affiliate points provided to the terminal user, and the terminal user can purchase or use a product or service traded on the shopping server 3b with the affiliate points.

A description will be given here of update of the transaction information table of the transaction target information DB 31 and the user information table of the user information DB 32.

The sale information transmitted from the shopping server 3b and the store terminal 4 includes the user ID of the terminal user being a transaction entity of a transaction target, and information on the transaction target. For example, if the terminal user has traded the transaction target not on the basis of the introduction information, the sale information transmitted from the shopping server 3b includes the user ID of the transaction user, and the transaction target's kind, name, quantity, icon information, purchase site, access information, and the like.

In this case, the acquisition unit 34 newly allocates a transaction target ID to the sale information acquired from the shopping server 3b, and sets the kind, name, quantity, icon information, purchase site, access information, and the like in the transaction information table stored in the transaction target information DB 31. Moreover, the acquisition unit 34 associates the newly allocated transaction target ID with the user ID of the transaction user in the user information table stored in the user information DB 32.

Moreover, if the terminal user has traded the transaction target on the basis of the introduction information, the sale information transmitted from the shopping server 3b includes the user ID of the transaction user, an introduction transaction target ID described below, quantity, and the like. In this case, the acquisition unit 34 associates the quantity with the transaction target ID corresponding to the introduction transaction target ID, and sets the quantity in the transaction information table.

In this manner, when acquiring the sale information, the acquisition unit 34 updates the transaction information table stored in the transaction target information DB 31 and the user information table stored in the user information DB 32 on the basis of the sale information.

Moreover, when acquiring the information transmitted from the terminal apparatus 2, the acquisition unit 34 updates the transaction information table stored in the transaction target information DB 31 and the user information table stored in the user information DB 32 on the basis of the information. For example, when acquiring information included in an introduction request (hereinafter described as the introduction request information) from the terminal apparatus 2, the acquisition unit 34 adds to the transaction information table a transaction target ID that is the transaction target ID included in the introduction request information with an additional or updated end. For convenience's sake, the transaction target ID added in this manner is described as the introduction transaction target ID.

For example, the acquisition unit 34 adds “P100a” as the introduction transaction target ID to the transaction information table if the transaction target ID included in the introduction request information is “P100,” and adds “P100b” as the introduction transaction target ID to the transaction information table if the transaction target ID included in the introduction request information is “P100a.”

Furthermore, the acquisition unit 34 sets the kind, name, icon information, purchase site, and access information corresponding to the newly added introduction transaction target ID in the transaction information table. These pieces of information are the kind, name, icon information, purchase site, and access information of the transaction target ID being the base of the introduction transaction target ID. For example, the kind, name, icon information, purchase site, and access information of the introduction transaction target ID “P100a” are the kind, name, icon information, purchase site, and access information of the transaction target ID “P100.”

3.2. Selection Unit 35

If the terminal user has made an introduction request, the selection unit 35 selects a user ID of another terminal user who is associated with the terminal user and who in the past visited a transaction site of a transaction target specified in the introduction request as a user ID of an introduction destination on the basis of the information stored in the transaction target information DB 31 and the user information DB 32.

Specifically, the selection unit 35 sets a terminal user with a friend ID associated with the user ID of the terminal user who has made the introduction request, as a terminal user associated with the terminal user who has made the introduction request (hereinafter described as the associated terminal user). For example, if a terminal user with a user ID “U2” (see FIG. 7) has made an introduction request, the selection unit 35 acquires friend IDs “U1,” “U3,” and the like set in the user information table, and sets terminal users having such friend IDs as the user IDs as the associated terminal users.

Next, the selection unit 35 determines whether or not a site where the associated terminal user visited in the past is within a predetermined related area with a transaction site of the transaction target specified in the introduction request (hereinafter described as the relevant area). The selection unit 35 then selects as the user ID of the introduction destination the user ID of the associated terminal user who visited a site within the relevant area in the past.

For example, if the transaction target specified in the introduction request is a sales service at a store of “shopG” and “latitude longitude A” is within a predetermined area of the store location of “shopG,” the selection unit 35 determines that a site that the terminal user with the user ID “U1” visited is within the relevant area, and selects the user ID “U1” as the user ID of the introduction destination.

When selecting the user ID as the user ID of the introduction destination, the selection unit 35 associates the transaction target ID of the transaction target to be introduced with the selected user ID of the introduction destination and sets the transaction target ID as the introduction transaction target ID in the user information table. For example, in the example illustrated in FIG. 7, the introduction transaction target IDs “P105a” and “P106a” are set having the user ID “U1” as the introduction destination user ID.

For example, if the transaction target specified in the introduction request is a product sold or a service offered in a store in the real space, the relevant area is a predetermined area from the store (for example, an area of 100 m from the store). Moreover, for example, if the transaction target specified in the introduction request is a product sold or a service offered on a shopping page in the virtual space, the relevant area is the shopping page and its related pages.

For example, if the transaction target specified in the introduction request is the “sunglasses A” sold on the shopping page of the shopping server 3b, the relevant area is the shopping page of the shopping server 3b that sells sunglasses including the “sunglasses A” and a site page of a manufacturer of the “sunglasses A.”

Moreover, the selection unit 35 can also set a visit period, the number of visits, and the like as selection conditions among sites that the associated terminal user visited in the past. For example, the selection unit 35 can determine whether or not a site that the associated terminal user visited during a period of time until a predetermined time before (for example, one week before) a predetermined day among past visit sites is within the relevant area.

Moreover, the selection unit 35 can select, as the user ID of the introduction destination, the user ID of the associated terminal user who visited a site within the relevant area a predetermined number of times (for example, three times) or more among the past visit sites. Moreover, the selection unit 35 can select, as the user ID of the introduction destination, the user ID of the associated terminal user who visited a site within the relevant area a predetermined number of times or more during a period of time until a predetermined time before a predetermined time among the past visit sites.

The selection unit 35 is capable of not selecting even the associated terminal user who visited a site within the relevant area in the past as the user ID of the introduction destination if the associated terminal user has already traded the transaction target specified in the introduction request.

Moreover, even if another terminal user has already introduced the transaction target specified in the introduction request to the associated terminal user who visited a site within the relevant area in the past, the selection unit 35 is capable of selecting the user ID of the associated terminal user as the user ID of the introduction destination.

3.3. Notification Unit 36

The notification unit 36 transmits the introduction information acquired by the acquisition unit 34 from the communication unit 30 to the terminal apparatus 2 of the user having the user ID of the introduction destination selected by the selection unit 35 (hereinafter described as the introduction destination user in some cases). Consequently, the introduction information can be notified to the introduction destination user.

The introduction information transmitted to the introduction destination user is information on the transaction target corresponding to the introduction request, and includes the transaction target ID, kind, name, icon information, and access information of the transaction target. The notification unit 36 reads from the transaction information table the transaction target ID, kind, name, icon information, and access information of the transaction target corresponding to the introduction request.

Moreover, the notification unit 36 sets the introduction value on the basis of the quantity of the transaction target corresponding to the introduction request. For example, the notification unit 36 increases the introduction value according to the quantity. In terms of the introduction value, the introduction value may be increased according not only to the quantity but also to the kind of the transaction target.

3.4. Provision Unit 37

If the terminal user of the transmission destination of the introduction information has traded the transaction target corresponding to the introduction information, the provision unit 37 provides the affiliate points as a reward to the terminal user of the terminal apparatus 2 of the introduction source.

The provision unit 37 determines that the terminal user of the transmission destination of the introduction information is the terminal user who has traded the transaction target corresponding to the introduction information, on the basis of the introduction transaction target ID included in the sale information transmitted from the shopping server 3b or the store terminal 4, and provides the affiliate points to the terminal user. Specifically, the affiliate points are provided to the terminal user having the user ID whose transaction target ID corresponding to the introduction transaction target ID included in the sale information transmitted from the shopping server 3b or the store terminal 4 is set in the user information table (hereinafter described as the introduction source user). The provision unit 37 can set, for example, a predetermined rate (for example, 5%) of a transaction price of the transaction target corresponding to the introduction transaction target ID to the affiliate points.

Moreover, the provision unit 37 decides on the affiliate points to be provided to the introduction source user on the basis of the user information table, for example, on the basis of the introduction transaction target ID set for the transaction target corresponding to the transaction target ID. For example, the provision unit 37 sets the affiliate points of the introduction transaction target ID included in the sale information transmitted from the shopping server 3b or the store terminal 4, the introduction transaction target ID ending with “b,” lower than the affiliate points of the introduction transaction target ID ending with “a.”

The and “a” of the introduction transaction target ID is a numeral assigned when a transaction target traded by the terminal user not on the basis of the introduction information is introduced. Moreover, the end “b” of the introduction transaction target ID is a numeral assigned when a transaction target traded by the terminal user on the basis of the introduction information of the introduction transaction target ID ending with “a” is introduced.

A numeral assigned when a transaction target traded by the terminal user on the basis of the introduction information of the introduction transaction target ID ending with “b” is introduced is an end “c.” The provision unit 37 sets the affiliate points of the introduction transaction target ID included in the sale information transmitted from the shopping server 3b or the store terminal 4, the introduction transaction target ID ending with “c,” lower than the affiliate points of the introduction transaction target ID ending with “b.” In this manner, the affiliate points become lower on every introduction.

The provision unit 37 transmits information on the provided affiliate points to the terminal apparatus 2 of the introduction source. Consequently, the terminal user of the terminal apparatus 2 of the introduction source can grasp the information on the provided affiliate points.

Moreover, if the same transaction target is introduced to the same terminal user by a plurality of other terminal users, and the transaction target is traded, the affiliate points are provided as rewards to the plurality of other terminal users. The provision unit 37 can set a higher affiliate point at an earlier introduction timing, and can also set a higher affiliate point at a later introduction timing.

4. Shopping Server 3b

Next, the shopping server 3b will be described. As illustrated in FIG. 2, the shopping server 3b includes a communication unit 40, a sale information DB 41, and a control unit 42. Furthermore, the control unit 42 includes a sale processing unit 43 and a notification unit 44.

The communication unit 40 is an interface such as an NIC. The control unit 42 transmits and receives various pieces of information to and from the affiliate server 3a and the terminal apparatus 2 via the communication unit 40 and the communication network 5.

The sale information DB 41 is, for example, a hard disk, a semiconductor memory device such as a RAM or a flash memory, or a storage device such as an optical disc. Information on a shopping page, information on a transaction target, and the like are included in the sale information DB 41.

The control unit 42 is realized by an integrated circuit such as an ASIC or an FPGA. Moreover, a CPU or an MPU executes programs stored in an internal storage device using a RAM as a workspace and accordingly the control unit 42 functions as the sale processing unit 43 and the notification unit 44. The configuration of the control unit 42 is not limited to such a configuration but may be another configuration as long as it is a configuration that performs information processing, which is described below.

The sale processing unit 43 provides a shopping page in response to access from the terminal apparatus 2 on the basis of the information stored in the sale information DB 41, and performs a sale process on a transaction target on the shopping page in response to the purchase request transmitted from the terminal apparatus 2. The sale process is, for example, a payment process and a delivery arrangement. The sale processing unit 43 notifies the completion of the sale process to the terminal apparatus 2 of the transmission source of the purchase request if the sale process is performed on the transaction target.

The notification unit 44 acquires information on the transaction target sold to the terminal user from the sale information DB 41, and transmits the information as the purchase result of the user terminal to the affiliate server 3a. The purchase result of the user terminal transmitted by the notification unit 44 includes the user ID of the terminal user in addition to, for example, information on the kind, name, quantity, icon information, purchase site, access information, and date and time of sale of the transaction target. The date and time of sale is, for example, a date and time when the sale processing unit 43 performs the sale process on the transaction target. Moreover, if the transaction target sold to the terminal user is a transaction target traded on the basis of the introduction information, the notification unit 44 transmits to the affiliate server 3a the introduction transaction target ID acquired from the terminal user, the quantity traded, and the user ID of an introducer as the purchase result of the user terminal.

5. Process Flow of Affiliate System 1

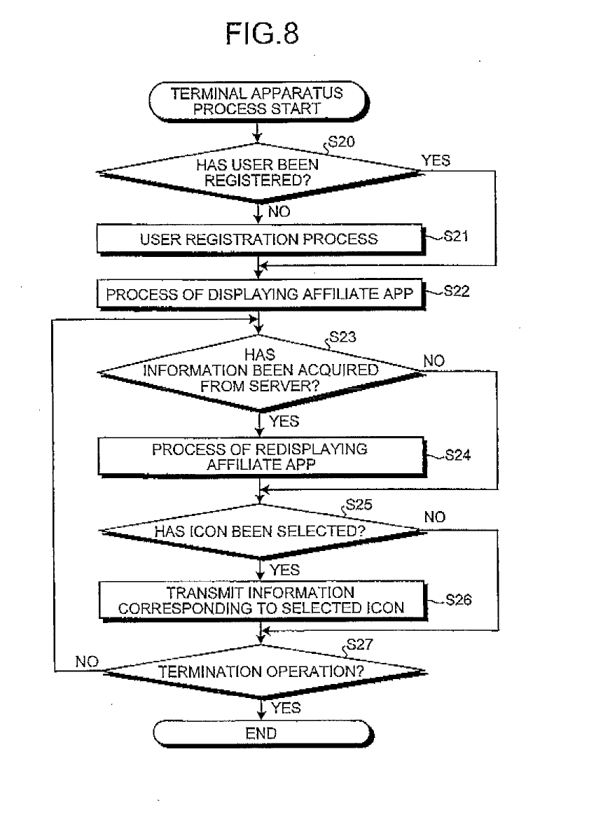

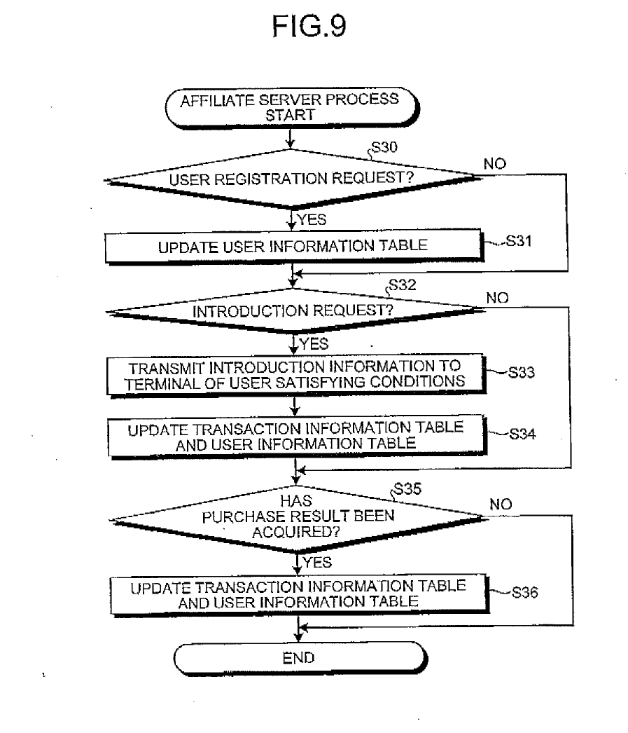

Next, a description will be given of a procedure for an information providing process by the affiliate system 1 according to the embodiment. FIGS. 8 and 9 are diagrams illustrating an affiliate process flow by the affiliate system 1. In the following, the process of the terminal apparatus 2 will be described with reference to FIG. 8, and the process of the affiliate server 3a with reference to FIG. 9.

5.1. Process Flow of Terminal Apparatus 2

Firstly, information processing of the terminal apparatus 2 according to the embodiment will be described with reference to FIG. 8. FIG. 8 is a flowchart of information processing in the terminal apparatus 2.

As illustrated in FIG. 8, when the affiliate app is activated by the operation of the terminal user, the control unit 25 of the terminal apparatus 2 determines whether or not the user has been registered (Step S20). If determining that the user has not been registered (step S20; No), the control unit 25 performs a user registration process (Step S21). The control unit 25 displays a user setting registration screen (not illustrated) on the display unit 21 in the user registration process and prompts the terminal user to input registration information. The registration information includes a user ID, a password, and user attributes (gender, age, address, and the like). If the registration information has been input, the control unit 25 transmits a registration request including the registration information to the affiliate server 3a.

If it is determined that the user has been registered (Step S20; Yes), or if the process of Step S21 is complete, a process of displaying the affiliate app is performed (Step S22). Specifically, the control unit 25 creates an image of the display screen 50 (for example, see FIG. 4) on the basis of the target information table stored in the storage unit 23, and displays the image on the display unit 21.

Next, the control unit 25 determines whether or not to have acquired information from the server 3 (Step S23). In the process, the control unit 25 determines, for example, whether or not to have acquired purchase information or introduction information from the affiliate server 3a, or whether or not to have acquired a sale process completion notice from the shopping server 3b.

If determining to have acquired information from the server 3 (Step S23; Yes), the control unit 25 performs a process of redisplaying the affiliate app (Step S24). For example, if having acquired purchase information from the affiliate server 3a, the control unit 25 sets the purchased icon 60 corresponding to the acquired purchase information on the display screen 50 and displays the display screen 50 on the display unit 21, and if having acquired introduction information from the affiliate server 3a, sets the introduction icon 61 corresponding to the acquired introduction information on the display screen 50 and displays the introduction icon 61 on the display unit 21.

Moreover, for example, if having acquired a sale process completion notice from the shopping server 3b in response to a purchase request of an introduced product, the control unit 25 changes the introduction icon 61 corresponding to the acquired sale process completion notice to the purchased icon 60, sets the purchased icon 60 on the display screen 50, and displays the purchased icon 60 on the display unit 21. In this case, the control unit 25 changes a state flag corresponding to the introduction icon 61 from “2” to “0” in the target information table to change the introduction icon 61 to the purchased icon 60.

If determining to have not acquired information from the server 3 in Step S23 (Step S23; No), or if completing the process of Step S24, the control unit 25 determines whether or not the purchased icon 60 or the introduction icon 61 set on the display screen 50 has been selected (Step S25).

If determining that the icon has been selected (Step S25; Yes), the control unit 25 transmits information corresponding to the selected icon in accordance with the selection method (Step S26). Assume, for example, that the flick operation has been performed on the introduction icon 61. In this case, if access information corresponding to the introduction icon 61 is a URL of the shopping server 3b, the control unit 25 makes a purchase request corresponding to the introduction icon 61 to the shopping server 3b. Moreover, if the access information corresponding to the introduction icon 61 is information for a barcode, the control unit 25 displays on the display unit 21a two-dimensional barcode corresponding to the access information and the user ID of the user terminal.

If determining that the icon has not been selected (Step S25; No), or if completing the process of Step S26, the control unit 25 determines whether or not the termination operation of the affiliate app has been performed by the terminal user (Step S27). If determining that the termination operation of the affiliate app has not been performed (Step S27; No), the control unit 25 shifts the processing to Step S23. If determining that the termination operation of the affiliate app has been performed (step S27; Yes), the control unit 25 terminates information processing.

5.2. Process Flow of Affiliate Server 3a

Next, information processing of the affiliate server 3a according to the embodiment will be described with reference to FIG. 9. FIG. 9 is a flowchart of information processing in the affiliate server 3a.

As illustrated in FIG. 9, the control unit 33 of the affiliate server 3a determines whether or not the terminal apparatus 2 has made a user registration request (Step S30). If determining that a user registration request has been made (Step S30; Yes), the control unit 33 updates the user information table (Step S31). In such a process, the control unit 33 sets a user ID included in the user registration request, and the like in the user information table. If the user registration request includes a friend ID, the friend ID is set in the user information table while being associated with the user ID. The friend ID can also be set by a friend registration request transmitted from the terminal apparatus 2.

If determining that a user registration request has not been made (Step S30; No), or if completing the process of Step S31, the control unit 33 determines whether or not to have received an introduction request from the terminal apparatus 2 (Step S32). In such a process, if determining to have received an introduction request (Step S32; Yes), the control unit 33 transmits introduction information to the terminal apparatus 2 of a terminal user who satisfies the introduction conditions (Step S33). The terminal user who satisfies the introduction conditions is a terminal user who is associated with the terminal user who has made the introduction request, and who in the past visited a transaction site of a transaction target specified in the introduction request.

If the process of Step S33 is complete, the control unit 33 updates the transaction information table and the user information table (Step S34). Specifically, the control unit 33 sets in the transaction information table the introduction transaction target ID newly allocated on the basis of a transaction target ID of the transaction target specified in the introduction request, and its corresponding information. Moreover, the control unit 33 sets in the user information table the introduction transaction target ID corresponding to the user ID of the user terminal who has transmitted the introduction request.

If determining to have not received an introduction request (Step S32; No), or if completing the process of Step S34, the control unit 33 determines whether or not to have acquired the purchase result of the user terminal from the shopping server 3b (Step S35). If determining to have acquired the purchase result of the user terminal from the shopping server 3b (Step S35; Yes), the control unit 33 updates the transaction information table and the user information table (Step S36).

If determining to have not acquired the purchase result of the user terminal (Step S35; No), and if completing the process of Step S36, the control unit 33 terminates information processing.

6. Modification and the Like

In the above description, if the terminal user performs the flick operation on the purchased icon 60, an introduction request is transmitted to the affiliate server 3a. On the other hand, if the terminal user performs a click operation on the purchased icon 60, the control unit 25 displays information on the purchased icon 60 on which the click operation has been performed, on the display unit 21 on the basis of the target information table. In this case, the information on the purchased icon 60 displayed on the display unit 21 is, for example, information on the name of a product corresponding to the purchased icon 60 and a reward of when the product corresponding to the purchased icon 60 is introduced (the affiliate points or affiliate fee). Moreover, the control unit 25 can also perform a process in accordance with access information of the purchased icon 60 on which the click operation has been performed on the basis of the target information table. The click operation is an example, and an operation may be another operation.

Moreover, in the above description, if the terminal user performs the flick operation on the purchased icon 60, an introduction request is transmitted to the affiliate server 3a, but it can also be configured such that an introduction request is transmitted to the affiliate server 3a if the terminal user has traded a transaction target. For example, if setting information of auto-affiliate is stored by the terminal user in the storage unit 23, the control unit 25 transmits an introduction request to the affiliate server 3a whenever purchase information is acquired. In this case, introduction information is transmitted to the affiliate server 3a, for example, only for the terminal user of a user ID set as a specific friend ID.

Moreover, if the terminal user performs an operation to move the purchased icon 60 and superimpose the purchased icon 60 on another purchased icon 60, the control unit 25 can also simultaneously transmit the two superimposed purchased icons 60 as introduction information to the affiliate server 3a. Consequently, for example, information on a plurality of related transaction targets can be introduced simultaneously, and the possibility of purchase by an introduction destination user can be increased.

Moreover, if the terminal user performs an operation to move the purchased icon 60 and superimpose the purchased icon 60 on the introduction icon 61, the control unit 25 can designate a user terminal of an introduction source corresponding to the introduction icon 61 and make an introduction request corresponding to the purchased icon 60. In this case, the control unit 33 of the affiliate server 3a transmits information on a transaction target corresponding to the purchased icon 60 as introduction information to the user terminal of the introduction source corresponding to the introduction icon 61.

Moreover, the control unit 33 may be configured to increase the introduction-value of a transaction target according to the number of repetition if the same terminal user repeatedly trades the same transaction target. Moreover, the control unit 33 may be configured to increase the introduction value of introduction information according to the number of terminal users who have made introductions if a plurality of terminal user introduces the same transaction target.

Moreover, the control unit 33 may be configured to transmit an affiliate completion notice to the terminal apparatus 2 of the terminal user who has made an introduction request if a transaction target has been traded on the basis of the introduction information. In this case, the control unit 25 of the terminal apparatus 2 that has made the introduction request may be configured to add information indicating the number of reception of the affiliate completion notice to the introduction icon 61 corresponding to the affiliate completion notice.

Moreover, the control unit 33 is configured to transmit introduction information to the terminal apparatus 2 of a terminal user who is associated with a terminal user who has made an introduction request and who in the past visited a transaction site of a transaction target specified in the introduction request, but is not limited to the introduction conditions. For example, the control unit 33 can also transmit introduction information to a terminal user whose current location is the transaction site of the transaction target specified in the introduction target. Moreover, the control unit 33 can also transmit introduction information to a terminal user whose future location is the transaction site of the transaction target specified in the introduction request.

Moreover, the terminal user can also set conditions to accept introduction information (hereinafter described as the acceptance conditions). The acceptance conditions are transmitted from the terminal apparatus 2 to the affiliate server 3a. The control unit 33 transmits introduction information that satisfies the acceptance conditions to the terminal apparatus 2 of the terminal user. The acceptance conditions include, for example, the area of a visit site, a period of time, the number of times, and the kind and content of a transaction target. In this manner, the terminal user sets the acceptance conditions to enable affiliate advertising appropriate for each terminal user.

Moreover, the control unit 25 of the terminal apparatus 2 is configured to make an introduction request by the flick operation but can also make an introduction request by performing a double click operation on the purchased icon 60 and moving the purchased icon 60 to the introduction information area 52 (see FIG. 4).

Moreover, the control unit 33 may be configured to notify information corresponding to the affiliate fee to the terminal apparatus 2 of a terminal user. In this case, the control unit 25 can display the purchased icon 60 on the display unit 21 in a manner where the information on the affiliate fee can be distinguished.

Moreover, the control unit 33 of the affiliate server 3a may be configured to notify the terminal apparatus 2 of a terminal user who is associated by a friend ID and for whom a transaction target that has not been traded is set as purchase information, of information to that effect. The control unit 25 can display the purchased icon 60 being the transaction target that has not been traded by the terminal user associated by the friend ID, on the display unit 21 in a distinguishable manner from other icons. Consequently, it is possible to encourage an introduction of a new transaction target.

In the embodiment, purchase information and introduction information that are transmitted from the affiliate server 3a include the transaction target ID, kind, name, icon information, and access information, but is not limited to such pieces of information, and various pieces of information can be set. For example, the purchase information and introduction information may be configured not to include information on kind and name. Moreover, if a transaction can be conducted only by the transaction target ID with the shopping server 3b or the store terminal 4, the purchase information and introduction information may be configured to include only the transaction target ID and icon information. Furthermore, if icons are not displayed on the terminal apparatus 2, the purchase information and introduction information may be configured to include only the transaction target ID and name.

In the embodiment, the description has been given assuming that the introduction information is transmitted from the terminal apparatus 2 to another terminal apparatus 2 via the server 3. However, the introduction information can also be transmitted by NFC between the terminal apparatus 2 and another terminal apparatus 2. In this case, the terminal apparatus 2 can transmit to another terminal apparatus 2 information including the transaction target ID of a transaction target being an introduction target, the user ID of a terminal user, and the like as introduction information. Another terminal apparatus 2 that has received the introduction information transmits a purchase request including the transaction target ID and the user ID to the shopping server 3b by the operation of the terminal user.

Moreover, in the embodiment, for example, eating and drinking at a restaurant and movie appreciation at a theater have been described, which serves to illustrate the use of a service. However, the use of a service is not limited to such illustrations. For example, the delivery of a catalog and materials of a transaction target, and the like can also be set by the above-mentioned processes as a reward target, counting them as the use of a service.

Moreover, in the embodiment, the introduction information is configured to include the transaction target ID, kind, name, icon information, and access information of a transaction target. However, the introduction information may be configured to further include a comment input by an introduction source user. For example, if the terminal user performs the flick operation on the purchased icon 60, the control unit 25 displays an introduction comment input screen on the display unit 21, prompts the terminal user to input an introduction comment, and transmits an introduction request including the input introduction comment to the affiliate server 3a. The control unit 33 of the affiliate server 3a includes the introduction comment acquired from the terminal apparatus 2 in the introduction request to transmit the introduction request to the terminal apparatus 2 of the introduction destination user. Consequently, it is possible to notify the introduction destination user of the comment of the introduction source user.

7. Effects

The affiliate system 1 according to the embodiment includes a plurality of the terminal apparatuses 2 (examples of a first terminal and a second terminal) and the affiliate server 3a (an example of a server). In the affiliate server 3a, the user information DB 32 (an example of an associated information storage unit) stores information that associates the terminal users (examples of users of the first and second terminals). The user information DB 32 (an example of a visit history storage unit) stores, as the visit history information, information on sites that the user of the terminal apparatus 2 (an example of the user of the second terminal) has visited. The acquisition unit 34 (an example of an introduction information acquisition unit) acquires an introduction request including information on a product or service decided to be introduced to another terminal user (an example of the user of the second terminal) among products or services purchased or used by the terminal user (an example of the user of the first terminal). The selection unit 35 (an example of a selection unit) selects another terminal user (an example of the user of the second terminal) who is associated with the terminal user (an example of the user of the first terminal) and who in the past visited a purchase site or use site of a product or service specified in the introduction request, on the basis of information stored in the user information DB 32. The notification unit 36 (an example of an introduction information notification unit) notifies introduction information corresponding to the introduction request acquired by the acquisition unit 34 to the terminal apparatus 2 (an example of the second terminal) of the terminal user selected by the selection unit 35. The provision unit 37 (an example of a provision unit) provides another terminal user (an example of the user of the first terminal) with the affiliate points or affiliate fee (an example of a reward) if the terminal user (an example of the user of the second terminal) purchases or uses a product or service on the basis of the introduction information.

With such a configuration, the introduction information is not transmitted to all terminals of users who are associated with the first terminal user, and advertisement distribution like spam can be inhibited. Hence, it is possible to prevent a situation where the introduction information tends to be ignored and to exert the effect of affiliate advertising effectively. Moreover, the introduction information is notified to a terminal of a user who has visited a purchase site of a product specified in the introduction request, which also enables the effect of affiliate advertising to be effectively exerted.

Moreover, in the terminal apparatus 2 (an example of the first terminal), the acquisition unit 26 (an example of an acquisition unit) acquires, as purchase information, information on a product or service purchased or used by the terminal user (an example of the user of the first terminal), the display unit 21 (an example of a display unit) displays the purchase information acquired by the acquisition unit 26, and the notification unit 28 (an example of a transmission unit) transmits to the affiliate server 3a an introduction request of the purchase information selected by the terminal user (an example of the user of the first terminal) among pieces of the purchase information displayed by the display unit 21.

With such a configuration, it is possible in the terminal apparatus 2 to easily introduce a product or service purchased or used by the terminal user to another terminal user.

Moreover, the purchase information includes information on an icon image corresponding to the product or service purchased or used by the terminal user (an example of the user of the first terminal). The display unit 21 displays the icon image as the purchase information. The notification unit 28 transmits to the affiliate server 3a an introduction request of the purchase information corresponding to the icon image selected by the terminal user (an example of the user of the first terminal) among the icon images displayed by the display unit 21.

With such a configuration, it is possible in the terminal apparatus 2 to easily introduce a product or service purchased or used by the terminal user to another terminal user by operating an icon image displayed by the display unit 21.

Moreover, in the terminal apparatus 2 (an example of the second terminal), the acquisition unit 26 acquires introduction information from the affiliate server 3a, the display unit 21 displays the introduction information acquired by the acquisition unit 26, and the notification unit 28 transmits request information that requests purchase or use of a product or service corresponding to the introduction information displayed by the display unit 21. In the affiliate server 3a, the provision unit 37 provides the affiliate points or affiliate fee to the terminal user (the user of the first terminal) if the product or service corresponding to the introduction information is purchased or used on the basis of the request information by the terminal apparatus 2 (an example of the second terminal).

With such a configuration, it is possible in the terminal apparatus 2 to purchase or use a product or service introduced by another terminal user.

Moreover, in the terminal apparatus 2 (an example of the second terminal), the acquisition unit 26 acquires, as purchase information, information on the product or service corresponding to the request information, the display unit 21 displays the purchase information acquired by the acquisition unit 26, and the notification unit 28 transmits to the affiliate server 3a an introduction request of the purchase information selected by the terminal user (an example of the user of the second terminal) among pieces of the purchase information displayed by the display unit 21. In the affiliate server 3a, the acquisition unit 26 acquires, as introduction information of the terminal apparatus 2 (an example of the second terminal), information in accordance with the introduction request of the terminal apparatus 2 (an example of the second terminal). In the terminal apparatus 2 (an example of a third terminal), the acquisition unit 26 acquires the introduction information of the terminal apparatus 2 (an example of the second terminal) from the affiliate server 3a, the display unit 21 displays the introduction information acquired by the acquisition unit 26, and the notification unit 28 transmits request information that requests purchase or use of the product or service corresponding to the introduction information displayed by the display unit 21. The provision unit 37 of the affiliate server 3a provides a terminal user (a user of the third terminal) with a reward that is lower than a reward provided to the terminal user (the user of the first terminal) if the product or service corresponding to the introduction information is purchased or used on the basis of the request information of the terminal apparatus 2 (an example of the third terminal).

With such a configuration, it is possible in the terminal apparatus 2 to purchase or use a product or service introduced by another terminal user and then introduce the product or service to still another terminal user. Consequently, it is possible to give a motivation to introduce a product or service that has not been introduced by another terminal user, and to increase the possibility that a new product or service is introduced.

Moreover, information on sites that the terminal user (the user of the second terminal) has visited includes the URL of a shopping page (an example of location information) that the terminal user (the user of the second terminal) has visited.

With such a configuration, it is possible to notify introduction information to a terminal user who may be interested in a product or service specified in an introduction request and be considering its purchase and to exert the effect of affiliate advertising more effectively.

Moreover, in the affiliate server 3a, the acquisition unit 34 (an example of a location information acquisition unit) acquires location information of the terminal apparatus 2 (an example of the second terminal), and information on sites that the terminal user (the user of the second terminal) has visited includes location information of the terminal apparatus 2 (an example of the second terminal) acquired by the acquisition unit 34.

With such a configuration, it is possible to notify introduction information to a terminal user who may be interested in a product or service specified in an introduction request and be considering its purchase and to exert the effect of affiliate advertising more effectively.

8. Others

The affiliate server 3a and the shopping server 3b may be realized by a plurality of server computers, and their configurations can be changed flexibly depending on the function by invoking an external platform and the like by an API (Application Programming Interface), network computing, and the like to realize the affiliate server 3a and the shopping server 3b.

An aspect of an embodiment can provide an affiliate system, an affiliate method, and a server that can perform affiliate advertising effectively.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An affiliate system comprising:
a first terminal;
a plurality of second terminals; and
a server, wherein
the server includes
an associated information storage unit configured to store information to associate a user of the first terminal with a user of the second terminal,
a visit history storage unit configured to store, as visit history information, information on a site visited by the user of the second terminal,
an introduction information acquisition unit configured to acquire an introduction request including information on a product or a service that the user of the first terminal decides to introduce to the user of the second terminal among products or services purchased or used by the user of the first terminal,
a selection unit configured to select, from among the users of the respective second terminals, the user of the second terminal who is associated with the user of the first terminal and who visits a purchase site or use site of the product or service specified in the introduction request, on the basis of the information stored in the associated information storage unit and the information stored in the visit history storage unit,
an introduction information notification unit configured to notify introduction information corresponding to the introduction request acquired by the introduction information acquisition unit to the second terminal of the user selected by the selection unit, and
a provision unit configured to provide a reward to the user of the first terminal when the user of the second terminal purchases or uses the product or service on the basis of the introduction information.

2. The affiliate system according to claim 1, wherein the first terminal includes
an acquisition unit configured to acquire, as purchase information, information on the product or service purchased or used by the user of the first terminal,
a display unit configured to display the purchase information acquired by the acquisition unit, and
a transmission unit configured to transmit to the server an introduction request corresponding to the purchase information selected by the user of the first terminal among pieces of the purchase information displayed by the display unit.

3. The affiliate system according to claim 2, wherein
the purchase information includes information on an icon image corresponding to the product or service purchased or used by the user of the first terminal,
the display unit displays the icon images as the purchase information, and
the transmission unit transmits to the server an introduction request corresponding to the purchase information corresponding to the icon image selected by the user of the first terminal from among the icon images displayed by the display unit.

4. The affiliate system according to claim 1, wherein
the second terminal includes
an acquisition unit configured to acquire the introduction information from the server,
a display unit configured to display the introduction information acquired by the acquisition unit, and
a transmission unit configured to transmit request information to request purchase or use of the product or service corresponding to the introduction information displayed by the display unit, and
the provision unit of the server provides a reward to the user of the first terminal when the user of the second terminal purchases or uses the product or service corresponding to the introduction information on the basis of the request information.

5. The affiliate system according to claim 4, comprising a plurality of third terminals, wherein
the acquisition unit of the second terminal acquires, as purchase information, information on the product or service corresponding to the request information,
the display unit of the second terminal displays the purchase information acquired by the acquisition unit of the second terminal,
the transmission unit of the second terminal transmits to the server an introduction request corresponding to the purchase information selected by the user of the second terminal among pieces of the purchase information displayed by the display unit of the second terminal,
the introduction information acquisition unit of the server acquires the introduction request of the second terminal,
the selection nit of the server selects, from among the users of the respective second terminals, a user of the third terminal who is associated with the user of the second terminal and who visits a purchase site or use site of the product or service specified in the introduction request,
the introduction information notification unit of the server notifies the third terminal of the user selected by the selection unit of introduction information corresponding to the introduction request from the second terminal,
the third terminal includes
an acquisition unit configured to acquire the introduction information of the second terminal from the server,
a display unit configured to display the introduction information acquired by the acquisition unit, and
a transmission unit configured to transmit request information to request purchase or use of the product or service corresponding to the introduction information displayed by the display unit, and
the provision unit of the server provides the user of the second terminal with a reward that is lower than a reward provided to the user of the first terminal when the user of the third terminal purchases or uses the product or service corresponding to the introduction information on the basis of the request information.

6. The affiliate system according to claim 1, wherein the information on a site visited by the user of the second terminal includes location information of a shopping page visited by the user of the second terminal.

7. The affiliate system according to claim 1, wherein
the server includes a location information acquisition unit configured to acquire location information of the second terminal, and
the information on a site visited by the user of the second terminal includes the location information of the second terminal acquired by the location information acquisition unit.

8. A server comprising:
an associated information storage unit configured to store information to associate a user of a first terminal with a user of a second terminal;
a visit history storage unit configured to store, as visit history information, information on a site visited by the user of the second terminal;
an introduction information acquisition unit configured to acquire an introduction request including information on a product or service that the user of the first terminal decides to introduce to the user of the second terminal among products or services purchased or used by the user of the first terminal;
a selection unit configured to select, from among users of the respective second terminals, the user of the second terminal who is associated with the user of the first terminal and who visits a purchase site or use site of the product or service specified in the introduction request on the basis of the information stored in the associated information storage unit and the visit history storage unit;
an introduction information notification unit configured to notify introduction information corresponding to the introduction request acquired by the introduction information acquisition unit to the second terminal of the user selected by the selection unit; and
a provision unit configured to provide a reward to the user of the first terminal when the user of the second terminal purchases or uses the product or service on the basis of the introduction information.

9. An affiliate method to be executed by a computer, comprising:
storing information to associate a user of a first terminal with a user of a second terminal in an associated information storage unit;
storing information on a site visited by the user of the second terminal, as visit history information, in a visit history storage unit;
acquiring an introduction request including information on a product or service that the user of the first terminal decides to introduce to the user of the second terminal among products or services purchased or used by the user of the first terminal;
selecting the user of the second terminal who is associated with the user of the first terminal, and who visits a purchase site or use site of the product or service specified in the introduction request, on the basis of the information stored in the associated information storage unit and the information stored in the visit history storage unit;
notifying introduction information corresponding to the introduction request acquired in the acquiring to the second terminal of the user selected in the selecting; and
providing a reward to the user of the first terminal when the user of the second terminal purchases or uses the product or service on the basis of the introduction information.
